(19) United States
(12) Patent Application Publication
(10) Pub. No.: US 2026/0124666 A1
(43) Pub. Date: May 7, 2026

(54) PRESS SYSTEM AND TRANSFER DEVICE

(71) Applicant: FUJI SPRINGS CO., INC., ASAGO-SHI, HYOGO (JP)

(72) Inventors: HIROYA KIMURA, ASAGO-SHI, HYOGO (JP); EIJI HASHIMOTO, ASAGO-SHI, HYOGO (JP)

(21) Appl. No.: 19/485,000

(22) PCT Filed: Jun. 24, 2024
(86) PCT No.: PCT/JP2024/022799

§ 371 Date: Nov. 17, 2025

(30) Foreign Application Priority Data
Jan. 29, 2024 (JP) 2024-010864

(51) Int. Cl. B21D 43/05; B21D 22/20; B21D 45/04

(52) U.S. Cl. CPC B21D 43/05; B21D 22/20; B21D 45/04

(57) ABSTRACT

To provide a press system enabling to take out a workpiece from below a die and achieve miniaturization and simplification of a device. The press system includes: a plurality of press working units each including a die 71 and a punch; and a transfer device 76 that transfers a workpiece processed in one press working unit to the next press working unit. The transfer device 76 includes: a plurality of transfer fingers 77 that clamp the workpiece from both sides in a direction perpendicular to a transfer direction of the workpiece; slide bars (78A, 78B) on which the plurality of transfer fingers 77 are disposed; a drive unit that drives the slide bars (78A, 78B) to reciprocate; stays 80 extending from the slide bars (78A, 78B) toward an underside of a specific die 71A; and an under-die removal finger 81 disposed on the stays 80, the under-die removal finger 81 clamping the workpiece moved to below the specific die 71A.

### FIELD OF THE DISCLOSURE

The present invention relates to a press system and a transfer device used for a press system.

### BACKGROUND OF THE DISCLOSURE

There has been known a press system that includes a plurality of press working units each including a die and a punch and performs a plurality of press drawing processes on a workpiece. For example, there is disclosed in Patent Document 1 a press system including a transfer device that transfers a workpiece processed in one of the plurality of press working units to a next press working unit.

In the press system of Patent Document 1, a workpiece take-out device 40 is provided to take out the workpiece, which has passed through a die of a final press working unit of the plurality of press working units. The workpiece take-out device 40 is configured to include a fixed base 41, a pair of first movable bases 43, a pair of second movable bases 44, a pair of arm units 50, a ball screw mechanism 60, a forward/backward drive unit 63, a pair of open/close drive units 52, etc. Note that the fixed base 41 is secured to a frame 11 and projects from an exterior surface of the frame 11, the frame 11 supporting a ram 14 and a bolster 16. The pair of first movable bases 43 is supported by the fixed base 41 so as to be movable in a first horizontal direction, and arranged side by side in a second horizontal direction. The pair of second movable bases 44 is supported by the pair of first movable bases 43 so as to be movable in the second horizontal direction. The pair of arm units 50 extends from the pair of second movable bases 44 to the bolster 16 side in the first horizontal direction. The ball screw mechanism 60 is supported by the fixed base 41 on the upper side than the first movable bases 43 and the second movable bases 44. The forward/backward drive unit 63 drives the ball screw mechanism 60 to move the pair of arm units 50 to a forward position inside the frame 11 and a backward position away from the frame 11 in the first horizontal direction. The pair of open/close drive units 52 is coupled to the pair of second bases 44, and moves the pair of arm units 50 to a closed position to clamp the workpiece and an open position separated from the workpiece.

### PRIOR ART DOCUMENTS

### Patent Documents

Patent Document 1: Japanese Patent No. 6626234

### SUMMARY OF THE DISCLOSURE

### Problems to be Solved

Incidentally, if it is possible to take out a workpiece subjected to press drawing from below a die, it is possible to remove the workpiece without passing the workpiece again through the bottom to the top of the die. This can prevent defects from occurring on the workpiece due to passing the workpiece again through the bottom to the top of the die. Therefore, it has been demanded to realize a device configuration capable of removing a workpiece from below a die. Further preferably, along with the removal of a workpiece from below a die as described above, it has been demanded to achieve miniaturization and simplification of the device.

The present invention has been made in view of the above-described circumstances, and an object thereof is to provide a press system and a transfer device enabling to take out a workpiece from below a die and also achieve miniaturization and simplification of the device.

### Means for Solving Problems

A first aspect of the present invention is a press system including a plurality of press working units each including a die and a punch to perform a plurality of press drawing processes on a workpiece, the press system further including:
a transfer device that transfers the workpiece processed in one of the plurality of press working units to a next press working unit,
wherein the transfer device includes:
a plurality of transfer fingers provided to clamp the workpiece from both sides in a direction perpendicular to a transfer direction of the workpiece;
a pair of slide bars extending along the transfer direction, on which the plurality of transfer fingers are disposed;
a drive unit that drives the slide bars to reciprocate along the transfer direction;
stays extending from the slide bars toward an underside of a specific die, the specific die being the die of any press working unit of the plurality of press working units; and
an under-die removal finger disposed on the stays, the under-die removal finger clamping the workpiece that has passed through a molding hole of the specific die and moved to below the specific die.

According to the above-described first aspect of the press system, the plurality of transfer fingers for clamping the workpiece are disposed on the slide bars, which are driven to reciprocate, and the stays on the slide bars extend toward the underside of the specific die. Further, the under-die removal finger for clamping the workpiece moved to below the specific die is disposed on the stays. This makes it possible to take out the workpiece from below the specific die by clamping the workpiece passed through the specific die with the under-die removal finger and driving the slide bars. Further, according to the above-described first aspect of the press system, it is possible to take out the workpiece from below the specific die by a small simple mechanism in which the slide bars of the transfer device are provided with the stays extending from the slide bars toward the underside of the specific die, and the under-die removal finger is disposed on the stays.

As described above, according to the above-described first aspect of the press system, it is possible to take out the workpiece from below the die, and also achieve miniaturization and simplification of the device.

A second aspect of the present invention is the press system, wherein, more preferably,
the press working unit including the specific die includes a specific die holder configured to support the specific die, and
the specific die holder is provided with an opening to insert the stays.

According to the above-described second aspect of the press system, the opening to insert the stays is disposed in the specific die holder configured to support the specific die, below which the workpiece is taken out. Accordingly, it is possible to easily insert the stays below the specific die.

A third aspect of the present invention is the press system, wherein the specific die holder is more preferably formed in a frame-like shape to support the specific die.

According to the above-described third aspect of the press system, the specific die holder is formed in the frame-like shape to support the specific die, so that the wide opening to insert the stays can be formed. Additionally, since the specific die holder has the frame-like shape, it can have a structure including leg portions on both sides of the opening, and can stably support the specific die regardless of the opening disposed in the specific die holder.

A fourth aspect of the present invention is the press system, wherein each of the stays more preferably includes a member that is secured to one of the slide bars and extends from the slide bars toward an underside of the specific die.

According to the above-described fourth aspect of the press system, each of the stays extending from the slide bars toward the underside of the specific die and including the under-die removal finger disposed thereon can be configured as a simple structure provided with a member that is secured to the slide bars and extends from the slide bars toward the underside of the specific die. Therefore, it is possible to achieve further miniaturization and simplification of the device.

A fifth aspect of the present invention is the press system, more preferably, further including:
a lower die set on which the plurality of press working units each including the die and a die holder configured to support the die are mounted, wherein
the die holder of each of the plurality of press working units is mounted on the lower die set,
the lower die set includes a step formed such that a height position of a mounting position of the specific die holder is lower than a height position of a mounting position of the die holder of the press working unit preceding the press working unit including the specific die holder, and
the specific die holder has a height dimension set to align a height position of an upper end surface of the specific die holder with a height position of an upper end surface of the die holder of the press working unit preceding the press working unit including the specific die holder.

According to the above-described fifth aspect of the press system, the upper end surface of the specific die holder is at the same level as the upper end surface of the die holder for the previous process, and the lower die set is provided with the step having a decreased height in the mounting position of the specific die holder. Accordingly, it is possible to form a vertically wide space to insert the stays in the specific die holder configured to support the specific die, below which the workpiece is taken out. This enables the stays to be easily inserted under the specific die.

A sixth aspect of the present invention is the press system, more preferably, further including:
a lower die set on which the plurality of press working units each including the die and a die holder configured to support the die is mounted, wherein
the die holder of each of the plurality of press working units is mounted on the lower die set,
the specific die holder is disposed to align a height position of an upper end surface of the specific die holder with an upper end surface of the die holder of the press working unit preceding the press working unit including the specific die holder, and
the die holder of the press working unit preceding the press working unit including the specific die holder has a height dimension set to be aligned with a height dimension of the specific die holder.

According to the above-described sixth aspect of the press system, the height of the upper end surface of the specific die holder is aligned with the height of the upper end surface of the die holder for the previous process, and the height dimension of the die holder for the previous process is set to be aligned with the height dimension of the specific die holder. Accordingly, it is possible to produce the die holder for the previous process and the specific die holder in the standardized and the same external form. Moreover, by appropriately setting the height dimensions of the die holder for the previous process and the specific die holder high, it is possible to form a vertically wide space to insert the stays in the specific die holder, thereby easily inserting the stays under the specific die. Furthermore, by reducing the thickness of an upper wall portion of the specific die holder and setting the height of the space inside the specific die holder high, it is possible to form a vertically wide space to insert the stays in the specific die holder, thereby easily inserting the stays under the specific die.

A seventh aspect of the present invention is a transfer device to be used for a press system including a plurality of press working units each including a die and a punch to perform a plurality of press drawing processes on a workpiece, the transfer device transferring the workpiece processed in one of the plurality of press working units to a next press working unit, the transfer device including:
a plurality of transfer fingers provided to clamp the workpiece from both sides in a direction perpendicular to a transfer direction of the workpiece;
a pair of slide bars extending along the transfer direction, on which the plurality of transfer fingers are disposed;
a drive unit that drives the slide bars to reciprocate along the transfer direction;
stays extending from the slide bars toward an underside of a specific die, the specific die being the die of any press working unit of the plurality of press working units; and
an under-die removal finger disposed on the stays, the under-die removal finger clamping the workpiece that has passed through a molding hole of the specific die and moved to below the specific die.

According to the above-described seventh aspect of the transfer device, the plurality of transfer fingers for clamping the workpiece are disposed on the slide bars, which are driven to reciprocate, and the stays on the slide bars extend toward the underside of the specific die. Further, the under-die removal finger for clamping the workpiece moved to below the specific die is disposed on the stays. This makes it possible to take out the workpiece from below the specific die by clamping the workpiece passed through the specific die with the under-die removal finger and driving the slide bars. Further, according to the above-described sixth aspect of the transfer device, it is possible to take out the workpiece from below the specific die by a small simple mechanism in which the slide bars are provided with the stays extending from the slide bars toward the underside of the specific die, and the under-die removal finger is disposed on the stays.

As described above, according to the above-described seventh aspect of the transfer device, it is possible to take out the workpiece from below the die and also achieve miniaturization and simplification of the device.

A eighth aspect of the present invention is the transfer device, wherein each of the stays more preferably includes a member that is secured to one of the slide bars and extends from the slide bars toward an underside of the specific die.

According to the above-described eighth aspect of the transfer device, each of the stays extending from the slide bars toward the underside of the specific die and including the under-die removal finger disposed thereon can be configured as a simple structure provided with a member that is secured to the slide bars and extends from the slide bars toward the underside of the specific die. Therefore, it is possible to achieve further miniaturization and simplification of the device.

### Advantageous Effects of the Invention

According to the present invention, it is possible to provide a press system and a transfer device that enable to take out a workpiece from below a die and also achieve miniaturization and simplification of the device.

### BRIEF DESCRIPTION OF THE DRAWINGS

FIG. 1 shows one example of a press system of the present embodiment.

FIG. 2 is a schematic perspective view of an enlarged main part of a press system.

FIG. 3 is a schematic perspective view of an enlarged main part of a press system, including its cross section.

FIG. 4 is a schematic cross-sectional view of an enlarged main part of a press system.

FIG. 5 shows a main part of a press system to describe operation of the press system.

FIG. 6 shows a main part of a press system to describe operation of the press system.

FIG. 7 shows a main part of a press system to describe operation of the press system.

FIG. 8 shows a main part of a press system to describe operation of the press system.

FIG. 9 shows a main part of a press system to describe operation of the press system.

FIG. 10 shows a main part of a press system to describe operation of the press system.

FIG. 11 shows a main part of a press system to describe operation of the press system.

FIG. 12 shows a main part of a press system to describe operation of the press system.

FIG. 13 shows a main part of a press system to describe operation of the press system.

FIG. 14 is a diagram for describing a shape of a specific die holder according to a modification.

FIG. 15 is a diagram for describing a shape of a specific die holder according to a modification.

FIG. 16 is a diagram for describing a shape of a specific die holder according to a modification.

FIG. 17 is a diagram for describing a shape of a specific die holder according to a modification.

### DETAILED DESCRIPTION OF THE EXEMPLARY EMBODIMENTS

Hereinafter, embodiments of the present invention will be described with reference to the drawings. Note that the present invention is widely applicable to a variety of uses as a press system that includes a plurality of press working units each including a die and a punch and performs a plurality of press drawing processes on a workpiece, and as a transfer device to be used for a press system to transfer a workpiece. In the following description, firstly, a schematic configuration of a press system according to an embodiment of the present invention will be described, and next, characteristic configurations of the press system and a transfer device according to the embodiment of the present invention will be described.

### 1. Outline of Press System

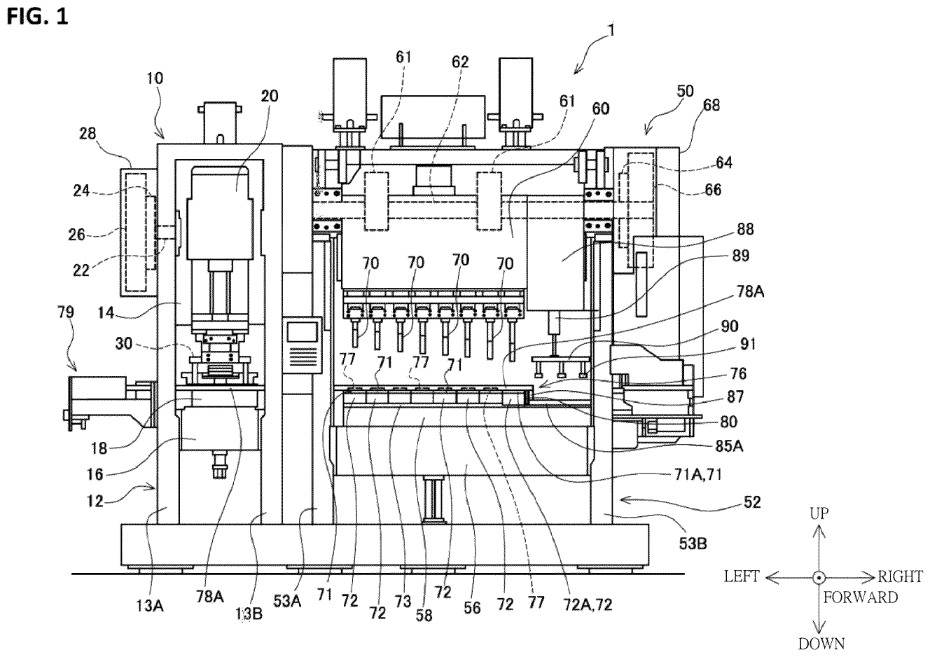

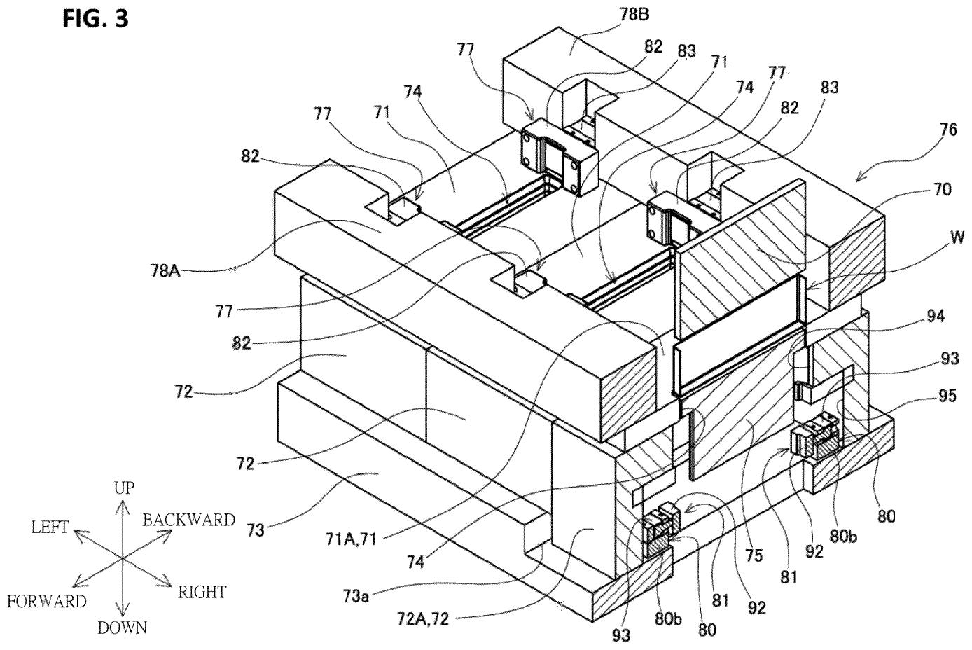

A press system 1 according to an embodiment of the present invention will be described with reference to FIGS. 1 to 3. Note that in the following description, an up-and-down direction, a left-and-right direction, and a forward-and-backward direction are defined as shown by arrows in FIGS. 1 to 3 and the other drawings described later. The up-and-down direction is defined based on a vertical direction. The left-and-right direction is defined as a direction parallel to a direction in which a workpiece W is transferred in the press system 1 (see FIG. 3). The forward-and-backward direction is defined as a direction perpendicular to both the up-and-down direction and the left-and-right direction.

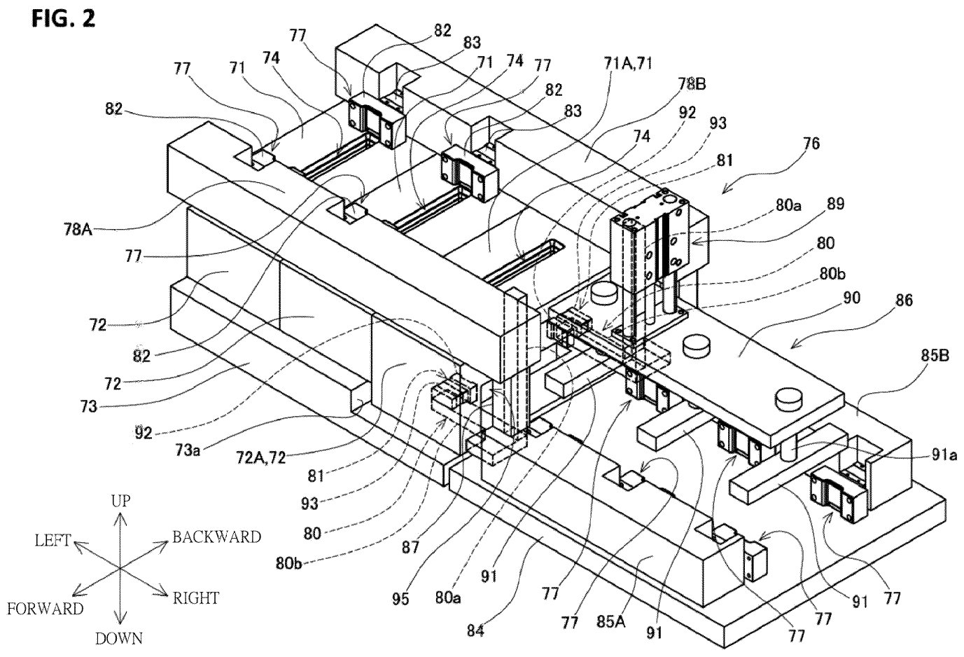

Referring to FIG. 1, the press system 1 is configured as a system that includes a plurality of press working units each including a die 71 and a punch 70 and performs a plurality of press drawing processes on a workpiece W. Note that the press system 1 is provided, for example, as a press system that performs a plurality of press drawing processes to form the workpiece W having a flat plate shape into a square tube having a bottom portion, thereby forming a square tubular bottomed container. The press system 1 is configured to include a workpiece supply device 10 and a transfer press apparatus 50. In the present embodiment, the workpiece supply device 10 is disposed on the left side while the transfer press apparatus 50 is disposed on the right side. The workpiece supply device 10 supplies the workpiece W to the transfer press apparatus 50. The transfer press apparatus 50 includes the plurality of press working units each including the die 71 and the punch 70. Note that FIGS. 2 and 3 show one of the plurality of press working units and an adjacent portion thereto disposed on a downstream side in the workpiece transfer direction, in the transfer press apparatus 50. Furthermore, in FIG. 3, the workpiece W to be processed by the final press working unit of the plurality of press working units, and the punch 70 of the final press working unit are also schematically shown including their cross sections.

The workpiece supply device 10 is a device configured to supply the workpiece W to the transfer press apparatus 50, and is disposed adjacent to an upstream side of the transfer press apparatus 50 in the workpiece transfer direction (transfer direction of the workpiece W). Note that the transfer direction of the workpiece W in the transfer press apparatus 50 is set as the left-and-right direction. The workpiece supply device 10 includes a frame 12 configured with a pair of sidewalls (13A, 13B), which vertically stand up and oppose to each other in the left-and-right direction. The frame 12 has a structure including a ram support wall 14, a bolster support wall 16, etc. laid between the pair of sidewalls (13A, 13B). Note that on a left side portion of the workpiece supply device 10, a drive unit 79 is disposed, which drives a pair of slide bars (78A, 78B) of a transfer device 76 as described later.

The ram support wall 14 supports a ram 20 to allow the ram 20 to move, i.e. ascend and descend, in the up-and-down direction. The ram 20 is movable in the up-and-down direction by receiving power from a servomotor (not shown) via a camshaft 22. Moreover, the ram 20 supports a punch (not shown). A left end of the camshaft 22 penetrates the left sidewall 13A of the pair of sidewalls (13A, 13B) opposite to each other in the left-and-right direction, and protrudes outside. To the portion penetrating the left sidewall 13A and protruding outside, the above-described servomotor (not shown) is coupled via a pulley 24 and a timing belt (not shown). When the camshaft 22 is rotationally driven by the servomotor (not shown), the ram 20 reciprocates up and down. Additionally, to the left end of the camshaft 22, a flywheel 26 as well as the pulley 24 are attached. Various members including the pulley 24, the timing belt (not shown), and the flywheel 26 are covered with a side cover 28 secured to an outer surface of the sidewall 13A.

The bolster support wall 16 supports a die holder 30 via a bolster 18. The die holder 30 has a two-stage structure including an upper stage unit and a lower stage unit. A top face of the lower stage unit of the die holder 30 is in a height position corresponding to a height position of a top face of the die 71 supported by a die holder 72 in the transfer press apparatus 50. The upper stage unit of the die holder 30 is disposed above and spaced apart from the top face of the lower stage unit. On the upper stage unit of the die holder 30, a die (not shown) is held.

In the workpiece supply device 10, the ram 20 is moved downward, and the punch (not shown) supported by the ram 20 and the die are used for blanking of a sheet metal, thereby forming the workpiece W into a flat plate shape. The workpiece W formed into the flat plate shape by the workpiece supply device 10 is fed to the transfer press apparatus 50.

Referring to FIG. 1, the transfer press apparatus 50 is disposed adjacent to the downstream side of the workpiece supply device 10 in the workpiece transfer direction. The workpiece W formed into the flat plate shape by the workpiece supply device 10 is transferred to the transfer press apparatus 50, and the transfer press apparatus 50 performs a plurality of press drawing processes on the workpiece W.

The transfer press apparatus 50 includes a frame 52 configured with a pair of sidewalls (53A, 53B), which vertically stand up and oppose to each other in the left-and-right direction. The frame 52 has a structure including a ram support wall (not shown), a bolster support wall 56, etc. laid between the pair of sidewalls (53A, 53B).

The ram support wall (not shown) supports a ram 60 to allow the ram 60 to move, i.e. ascend and descend, in the up-and-down direction. The ram 60 is movable in the up-and-down direction by receiving power from a servomotor (not shown) via a camshaft 62. Moreover, the ram 60 supports a plurality of punches 70 disposed along the left-and-right direction (i.e. transfer direction of the workpiece W). Between the pair of sidewalls (53A, 53B), the camshaft 62 is laid above the ram support wall (not shown). A cam 61 of the camshaft 62 is engaged with the ram 60.

A right end of the camshaft 62 penetrates the right sidewall 53B of the pair of sidewalls (53A, 53B) opposite to each other in the left-and-right direction, and protrudes outside. The portion penetrating the right sidewall 53B and protruding outside is coupled to the above-described servomotor (not shown) via a pulley 64 and a timing belt (not shown).

When the camshaft 62 is rotationally driven by the servomotor (not shown), the ram 60 reciprocates up and down. Additionally, to the right end of the camshaft 62, a flywheel 66 as well as the pulley 64 are attached. Various members including the pulley 64, the timing belt (not shown), and the flywheel 66 are covered with a side cover 68 secured to an outer surface of the sidewall 53B.

The bolster support wall 56 is laid between lower end portions of the pair of sidewalls (53A, 53B), and a bolster 58 is secured to a top face of the bolster support wall 56. Additionally, the transfer press apparatus 50 includes a plate-like lower die set 73 disposed on a top face of the bolster 58. On the lower die set 73, the plurality of press working units are mounted, each press working unit including the die 71 and the die holder 72 configured to support the die 71. More specifically, on the lower die set 73, the die holders 72 of the plurality of press working units are mounted. Furthermore, in the transfer press apparatus 50, the number of the plurality of dies 71 is the same as the number of the plurality of punches 70. A pair of the punch 70 and the die 71 arranged one above the other, and the die holder 72 configured to support the die 71 constitute one of the plurality of press working units.

Referring to FIGS. 1 to 3, the transfer press apparatus 50 is provided as an apparatus that includes the plurality of press working units each including the die 71 and the punch 70 and performs a plurality of press drawing processes on the workpiece W. The plurality of press working units each configured to include the die 71 and the punch 70 are arranged side by side along the left-and-right direction, i.e. the workpiece transfer direction, and a plurality of pairs of the die 71 and the punch 70 are respectively arranged at a constant pitch in the left-and-right direction. The die 71 of each press working unit is secured to a top face of the die holder 72. The die 71 is provided with a molding hole 74 having a long hole shape in plan view, as viewed in the up-and-down direction. The press drawing process is performed by pushing in and passing the workpiece W through the elongated molding hole 74 of the die 71 by the punch 70. The punch 70 pushes the workpiece W into the elongated molding hole 74 of the die 71, so that the workpiece W is formed into a cylindrical form having an elongated cross-sectional shape. Additionally, a knockout pin 75 is disposed in a corresponding position below the molding hole 74 of the die 71. When the punch 70 pushes the workpiece W into the molding hole 74 of the die 71 to mold the workpiece W, the knockout pin 75 presses a bottom face of the workpiece W upward to regulate downward swelling of the workpiece W. Additionally, while the punch 70 is moving upward or after the punch 70 is pulled out of the workpiece W, the knockout pin 75 can upwardly push the workpiece W out of the molding hole 74 of the die 71.

Additionally, the transfer press apparatus 50 includes a transfer device 76 that transfers the workpiece W processed in one of the plurality of press working units to the next press working unit. Transfer of the workpiece W to the downstream side in the workpiece transfer direction is performed by the transfer device 76. The workpiece W is transferred to the downstream side in the workpiece transfer direction by the transfer device 76, and subjected to press drawing by each of the plurality of pairs of the die 71 and the punch 70 arranged in the left-and-right direction.

Referring to FIGS. 1 to 3, the transfer device 76 provided on the transfer press apparatus 50 of the press system 1 is configured as the transfer device according to the embodiment of the present invention. That is, the transfer device 76 is configured as a device used for the press system 1, which includes the plurality of press working units each including the die 71 and the punch 70 and performs a plurality of press drawing processes on the workpiece W, the device transferring the workpiece W processed in one of the plurality of press working units to the next press working unit.

The transfer device 76 includes: a plurality of transfer fingers 77; a pair of slide bars (78A, 78B), on which the plurality of transfer fingers 77 are disposed; and a drive unit 79 that drives the slide bars (78A, 78B) to reciprocate. Additionally, the transfer device 76 includes stays 80 and an under-die removal finger 81, which are constituent components of a mechanism for taking out the workpiece W from below a specific die 71A, i.e. the die 71 of any press working unit of the plurality of press working units. The stays 80 extend from ends of the slide bars (78A, 78B), respectively, and the under-die removal finger 81 is disposed on the stays 80.

Note that in the present embodiment, the stays 80 extend from the ends of the slide bars (78A, 78B), respectively, but are not limited thereto. The slide bars (78A, 78B) may extend further, and the stay 80 may extend from the middle of the long slide bars (78A, 78B). Further in the present embodiment, the specific die 71A is configured as the die 71 of the final press working unit of the plurality of press working units. Note that the specific die 71A may not be configured as the die 71 of the final press working unit. The specific die 71 A may be configured as any die of the plurality of press working units other than the final press working unit.

Referring to FIGS. 1 to 3, the slide bars (78A, 78B) of the transfer device 76 are provided in pairs and disposed on the plurality of dies 71 arranged along the transfer direction of the workpiece W (workpiece transfer direction). The pair of slide bars (78A, 78B) are slidable on the die 71 along the transfer direction of the workpiece W, and provided as shaft-like members extending along the transfer direction of the workpiece W (i.e. left-and-right direction). On the pair of slide bars (78A, 78B), the plurality of transfer fingers 77 are disposed. Moreover, the pair of slide bars (78A, 78B) are arranged parallel to and at a certain distance from each other in the forward-and-backward direction. Note that, in FIGS. 2 and 3, only a part of the slide bars (78A, 78B) of the transfer device 76 is shown, and illustration of the left portions of the slide bars (78A, 78B) is omitted. In the present embodiment, the pair of slide bars (78A, 78B) are disposed on the plurality of dies 71 arranged along the workpiece transfer direction, but not limited thereto. While the plurality of dies 71 are arranged along the workpiece transfer direction, the pair of slide bars (78A, 78B) may be disposed on both sides of the plurality of dies 71 in the forward-and-backward direction (i.e. on both sides in the direction vertical to the workpiece transfer direction).

Referring to FIG. 1, the drive unit 79 is provided as a mechanism that drives the pair of slide bars (78A, 78B) to reciprocate along the transfer direction of the workpiece W (workpiece transfer direction). The drive unit 79 is configured to include a ball screw mechanism or a cylinder mechanism, which is coupled to one end of each of the pair of slide bars (78A, 78B) in the workpiece transfer direction. In the present embodiment, the ball screw mechanism or the cylinder mechanism of the drive unit 79 is coupled to the respective left ends of the pair of slide bars (78A, 78B). The ball screw mechanism or the cylinder mechanism of the drive unit 79 is operated such that the pair of slide bars (78A, 78B) is driven to reciprocate along the workpiece transfer direction.

Referring to FIGS. 1 to 3, the plurality of transfer fingers 77 are provided to clamp the workpiece W from both sides in the direction perpendicular to the transfer direction of the workpiece W, and provided as a mechanism for clamping and transferring the workpiece W along the transfer direction. Note that in the present embodiment, each of the plurality of transfer fingers 77 is provided to clamp the workpiece W from both sides in the forward-and-backward direction perpendicular to the left-and-right direction, i.e. the transfer direction of the workpiece W. Moreover, the plurality of transfer fingers 77 are disposed on the pair of slide bars (78A, 78B). The plurality of transfer fingers 77 are disposed on the pair of slide bars (78A, 78B), each in a position corresponding to each of the plurality of press working units. Accordingly, when the pair of slide bars (78A, 78B) is driven by the drive unit 79 to move along the workpiece transfer direction, the plurality of transfer fingers 77 also move along the workpiece transfer direction together with the pair of slide bars (78A, 78B). This enables the workpiece W clamped by the transfer fingers 77 to be transferred to the downstream side in the workpiece transfer direction.

Each of the plurality of transfer fingers 77 includes a pair of finger body parts 82, and a pair of air cylinders 83 as a drive source to respectively drive the pair of finger body parts 82 along the forward-and-backward direction. The pair of finger body parts 82 in the transfer finger 77 is provided as a unit that abuts on the workpiece W from both sides in the forward-and-backward direction to directly grasp the workpiece W at both sides in the forward-and-backward direction. Additionally, each of the pair of finger body parts 82 is attached to a tip of each rod of the pair of air cylinders 83. Then, each cylinder body part of the pair of air cylinders 83 is securely attached to each of the pair of slide bars (78A, 78B). In the respective transfer fingers 77, the pair of finger body parts 82 is configured to be openable and closable by operating the pair of air cylinders 83. In the pair of air cylinders 83, one air cylinder 83 and the other air cylinder 83 displace in contrast to each other in the forward-and-backward direction. When operating to displace the pair of finger body parts 82 from an open state to a closed state, the pair of air cylinders 83 drives the pair of finger body parts 82 to displace in a direction approaching to each other. On the other hand, when operating to displace the pair of finger body parts 82 from the closed state to the open state, the pair of air cylinders 83 drives the pair of finger body parts 82 to displace in a direction away from each other. In this manner, the transfer fingers 77 are configured to be able to release or clamp the workpiece W by the opening and closing operation of the finger body parts 82.

Note that a space between the adjacent transfer fingers 77 in the workpiece transfer direction (i.e. left-and-right direction) is at a constant pitch same as a space between the adjacent punches 70 and a space between the adjacent dies 71 in the left-and-right direction. The drive unit 79, in synchronization with the up and down operation of the ram 60, repeatedly causes the reciprocating operation of the pair of slide bars (78A, 78B) at a constant pitch in the left-and-right direction while maintaining the pair of slide bars (78A, 78B) in a horizontal state. Furthermore, the pair of air cylinders 83 of the respective transfer fingers 77 repeats the opening and closing operation of the pair of finger body parts 82 such that the workpiece W is transferred by the reciprocating operation of the pair of slide bars (78A, 78B) in the left-and-right direction. In this manner, the workpiece W is transferred by the transfer device 76 from the upstream side (i.e. left side) to the downstream side (i.e. right side) in the workpiece transfer direction, and sequentially subjected to the press drawing process by the die 71 and the punch 70 in each of the plurality of press working units. Accordingly, a plurality of press drawing processes are performed on the workpiece W.

Upon performing the plurality of press drawing processes on the workpiece W by the press system 1, the numbers of the dies 71 and the punches 70 to be used each correspond to the number of the press drawing processes to be performed. Note that in the press system 1 illustrated in FIG. 1, the illustrated embodiment includes eight pairs of the die 71 and the punch 70. When the workpiece W is subjected to eight press drawing processes, eight pairs of the die 71 and the punch 70 are used. For example, when the workpiece W is subjected to five press drawing processes, only five pairs of the die 71 and the punch 70 are used. That is, in this case, in the press system 1, any five of the eight pairs of the die 71 and the punch 70 are only attached for use, while the other three pairs of the die 71 and the punch 70 are not attached to the press system 1. Note that a block-shaped member provided with no molding hole, for example, is attached to a section of the press system 1 where the die 71 is not attached.

Additionally, in the transfer press apparatus 50, a workpiece carry-out area is provided to carry out the workpiece W on which the plurality of press drawing processes have been completed, while transferring the workpiece W to the downstream side in the workpiece transfer direction relative to the plurality of press working units each including the die 71 and the punch 70. The workpiece W transferred through the workpiece carry-out area and carried out is, for example, transferred to an apparatus that performs a post process after the processes by the press system 1. Referring to FIGS. 1 and 2, the workpiece carry-out area is provided with a plate 84 disposed on the top face of the bolster support wall 56, a pair of lower slide bars (85A, 85B) disposed on the plate 84, and a workpiece hold down mechanism 86 disposed above the plate 84 and the pair of lower slide bars (85A, 85B).

The plate 84 is adjacent to the lower die set 73 on the downstream side in the workpiece transfer direction. The workpiece W on which the plurality of press drawing processes have been completed is transferred along the plate 84 and carried out.

Referring to FIGS. 1 and 2, the pair of lower slide bars (85A, 85B) are slidable on the plate 84 along the workpiece transfer direction, and provided as shaft-like members extending along the workpiece transfer direction (i.e. left-and-right direction). Moreover, the pair of lower slide bars (85A, 85B) are arranged parallel to and at a certain distance from each other in the forward-and-backward direction. Each of the pair of lower slide bars (85A, 85B) is coupled to each of the pair of slide bars (78A, 78B) at the end of the upstream side in the workpiece transfer direction via a coupling member 87 that vertically extends. Note that the end of the lower slide bar 85A on the upstream side in the workpiece transfer direction is coupled to the end of the slide bar 78A on the downstream side in the workpiece transfer direction via the coupling member 87. Then, the end of the lower slide bar 85B on the upstream side in the workpiece transfer direction is coupled to the end of the slide bar 78B on the downstream side in the workpiece transfer direction via the coupling member 87. Moreover, the coupling member 87 extends downward from each end of the slide bars (78A, 78B) and is coupled to each end of the lower slide bars (85A, 85B). Therefore, the pair of lower slide bars (85A, 85B) are disposed below the pair of slide bars (78A, 78B). The pair of lower slide bars (85A, 85B) are respectively coupled to the pair of slide bars (78A, 78B), so that when the pair of slide bars (78A, 78B) are driven to reciprocate along the workpiece transfer direction, the pair of lower slide bars (85A, 85B) are also driven to reciprocate along the workpiece transfer direction together with the pair of slide bars (78A, 78B).

Further referring to FIG. 2, on the pair of lower slide bars (85A, 85B), a plurality of transfer fingers 77 are disposed. The transfer fingers 77 disposed on the pair of lower slide bars (85A, 85B) are configured in the same manner as the transfer fingers 77 disposed on the pair of slide bars (78A, 78B). The plurality of transfer fingers 77 disposed on the pair of lower slide bars (85A, 85B) are provided to clamp the workpiece W from both sides in the forward-and-backward direction perpendicular to the workpiece transfer direction, and provided as a mechanism for clamping and transferring the workpiece W along the transfer direction. When the pair of slide bars (78A, 78B) is driven by the drive unit 79 to move, the pair of lower slide bars (85A, 85B) also moves along with the pair of slide bars (78A, 78B). Then, the plurality of transfer fingers 77 disposed on the pair of lower slide bars (85A, 85B) also move along the workpiece transfer direction together with the pair of lower slide bars (85A, 85B). This causes the workpiece W clamped by the transfer fingers 77 disposed on the pair of lower slide bars (85A, 85B) to be transferred in the workpiece carry-out area toward the downstream side in the workpiece transfer direction.

Referring to FIGS. 1 and 2, the workpiece hold down mechanism 86 is provided as a mechanism for holding down the workpiece W from above and supporting the same when the workpiece W is not clamped by the transfer finger 77 disposed on the pair of lower slide bars (85A, 85B). The workpiece hold down mechanism 86 includes: an air cylinder 89 extending downward from a cylinder support wall 88 adjacent to the ram 60 in an upper area of the transfer press apparatus 50; a presser plate 90 attached to a lower end of the air cylinder 89; and a plurality of workpiece pressers 91 disposed below the presser plate 90.

The air cylinder 89 is provided to drive the presser plate 90 to reciprocate along the up-and-down direction. The plurality of workpiece pressers 91 are coupled to the presser plate 90 via arms 91a extending downward from the presser plate 90, and disposed below the presser plate 90. Each of the plurality of workpiece pressers 91 is configured to abut on an upper end of the workpiece W to hold down the workpiece W from above, thereby supporting the workpiece W. When the workpiece W is transitioned from a clamped state by the transfer finger (85A, 85B) to a not-clamped state, the air cylinder 89 is activated so that the presser plate 90 descends and the plurality of workpiece pressers 91 also descend along with the presser plate 90. Then, the descended plurality of workpiece pressers 91 each abuts on the upper end of the workpiece W to hold down the workpiece W, thereby supporting the workpiece W. Furthermore, when the workpiece W is transitioned from the not-clamped state to the clamped state by the transfer finger (85A, 85B), the air cylinder 89 is activated so that the presser plate 90 ascends and the plurality of workpiece pressers 91 also ascend along with the presser plate 90. This releases the workpiece W from the supported state by the workpiece hold down mechanism 86. In this manner, when the workpiece W is not clamped by the transfer finger 77, the workpiece W is supported by the workpiece hold down mechanism 86 so as to prevent the workpiece W from falling down.

### 2. Characteristic Configurations of Press System and Transfer Device

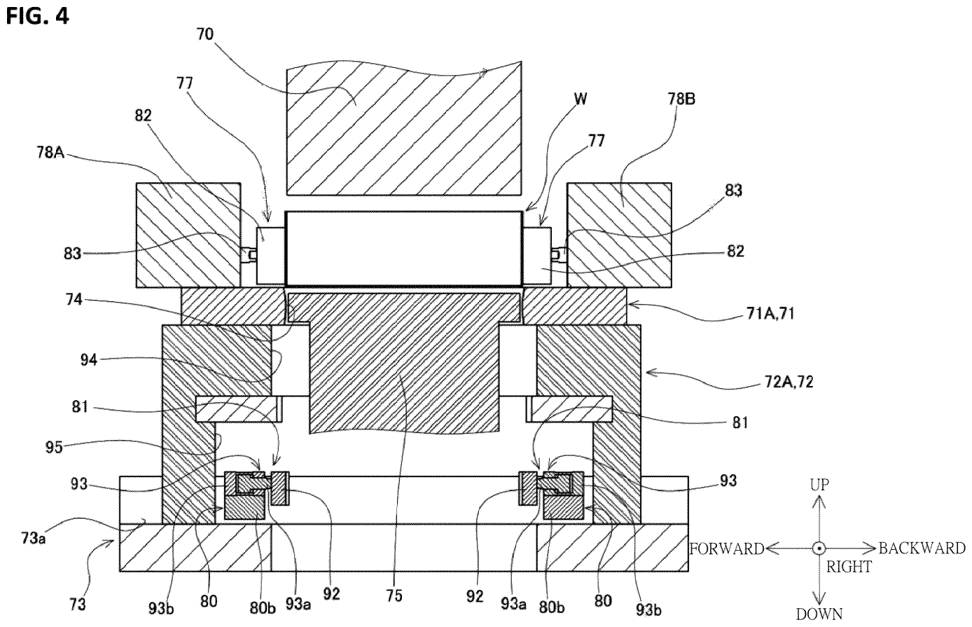

Next, characteristic configurations of the press system 1 of the present embodiment and the transfer device 76 of the present embodiment to be used for the press system 1 will be described. FIG. 4 is a schematic cross-sectional view of an enlarged main part of the press system 1, as taken along a cross section perpendicular to the left-and-right direction. Note that FIG. 4 is the cross-sectional view taken in a position corresponding to the specific die 71A configured as the die 71 of the final press working unit of the plurality of press working units.

Referring to FIGS. 1 to 4, the transfer device 76 of the press system 1 is configured to be able to take out the workpiece W from below the specific die 71A, which is configured as the die 71 of the final press working unit of the plurality of press working units. The transfer device 76 includes the stay 80 and the under-die removal finger 81 in order to configure a mechanism for taking out the workpiece W from below the specific die 71A.

Referring to FIGS. 1 to 4, the stay 80 is provided as a member extending from the slide bars (78A, 78B) toward an underside of the specific die 71A. In the transfer device 76, the stay 80 is provided as a pair of stays 80, and each of the pair of stays 80 extends from each of the pair of slide bars (78A, 78B) toward the underside of the specific die 71A. That is, one of the pair of stays 80 extends toward the underside of the specific die 71A from the slide bar 78A. Then, the other stay 80 of the pair of stays 80 extends toward the underside of the specific die 71A from the slide bar 78B.

Additionally, the stay 80 includes a member, which is secured to the slide bars (78A, 78B) and extends from the slide bars (78A, 78B) toward the underside of the specific die 71A. More specifically, in the present embodiment, the stay 80 is configured to include a vertical member 80a and a horizontal member 80b. The vertical member 80a is provided as a square rod member, which is secured to the slide bars (78A, 78B) and extends downward from the slide bars (78A, 78B) along the up-and-down direction. The vertical member 80a of one of the pair of stays 80 is securely attached to the slide bar 78A, while the vertical member 80a of the other stay 80 of the pair of stays 80 is securely attached to the slide bar 78B. Note that each end of the slide bars (78A, 78B) on the downstream side in the workpiece transfer direction is arranged in a position further projecting to the downstream of the specific die 71A in the workpiece transfer direction. Then, an upper end portion of the vertical member 80a of the stay 80 is secured to the end of the slide bars (78A, 78B) on the downstream side in the workpiece transfer direction. Further, the vertical members 80a are secured to inner side faces of the pair of slide bars (78A, 78B) in the forward-and-backward direction. Additionally, the vertical member 80a extends downward from the end of the slide bars (78A, 78B) in a position downstream of the specific die 71A in the workpiece transfer direction.

The horizontal member 80b of the stay 80 is provided as an elongated plate-like member, which is secured to the vertical member 80a and extends from the vertical member 80a toward the underside of the specific die 71A along a horizontal direction. That is, in each of the pair of stays 80, the horizontal member 80b is secured to the vertical member 80a, and extends from the vertical member 80a toward the underside of the specific die 71A along the horizontal direction. Furthermore, the horizontal member 80b is secured to a lower end of the vertical member 80a. Then, the horizontal member 80b extends from the lower end of the vertical member 80a toward the upstream side in the workpiece transfer direction, and thus extends toward the underside of the specific die 71. Additionally, the under-die removal finger 81 is disposed on tip sides of the horizontal members 80b extending from the vertical members 80a toward the underside of the specific die 71.

Referring to FIGS. 2 to 4, the under-die removal finger 81 is disposed on the stays 80 and provided as a mechanism for clamping the workpiece W, which has passed through the molding hole 74 of the specific die 71A and moved to below the specific die 71A. Further in the present embodiment, the under-die removal finger 81 is provided to clamp the workpiece W from both sides in the forward-and-backward direction perpendicular to the workpiece transfer direction, and is provided as a mechanism for clamping the workpiece W and taking out the workpiece W from below the specific die 71A to the downstream side in the workpiece transfer direction. Moreover, the under-die removal finger 81 is disposed on the horizontal members 80b of the pair of stays 80, which are respectively secured to the pair of slide bars (78A, 78B). Further, the under-die removal finger 81 is disposed on the horizontal members 80b of the stays 80 under the specific die 71A, such that it can be arranged in a position corresponding to the molding hole 74 of the specific die 71A. When the pair of slide bars (78A, 78B) is driven by the drive unit 79 to move, the pair of stays 80 also moves together with the pair of slide bars (78A, 78B). Then, the under-die removal finger 81 disposed on the pair of stays 80 also moves together with the pair of stays 80 to the downstream side in the workpiece transfer direction. This causes the workpiece W clamped below the specific die 71A by the under-die removal finger 81 to be taken out from below the specific die 71A to the downstream side in the workpiece transfer direction.

Further referring to FIGS. 2 to 4, the under-die removal finger 81 includes a pair of finger body parts 92, and a pair of air cylinders 93 as a drive source to drive each of the pair of finger body parts 92 along the forward-and-backward direction. The pair of finger body parts 92 in the under-die removal finger 81 is provided as a unit that abuts on the workpiece W from both sides in the forward-and-backward direction to directly grasp the workpiece W at both sides in the forward-and-backward direction. Moreover, each of the pair of finger body parts 92 is attached to a tip of each rod 93a of the pair of air cylinders 93. Then, each cylinder body part 93b of the pair of air cylinders 93 is securely attached to each horizontal member 80b of the pair of stays 80. Note that the cylinder body part 93b of the air cylinder 93 is secured to a top face of the horizontal member 80b. In the under-die removal finger 81, the pair of finger body parts 92 is configured to be openable and closable by operating the pair of air cylinders 93. In the pair of air cylinders 93, one air cylinder 93 and the other air cylinder 93 displace in contrast to each other in the forward-and-backward direction. When operating to displace the pair of finger body parts 92 from an open state to a closed state, the pair of air cylinders 93 drives the pair of finger body parts 92 to displace in a direction approaching to each other. On the other hand, when operating to displace the pair of finger body parts 92 from the closed state to the open state, the pair of air cylinders 93 drives the pair of finger body parts 92 to displace in a direction away from each other. In this manner, the under-die removal finger 81 is configured to be able to release or clamp the workpiece W by the opening and closing operation of the finger body parts 92.

Referring to FIGS. 2 to 4, the press working unit including the specific die 71A includes, as the die holder 72 for supporting the die 71, a specific die holder 72A configured to support the specific die 71A. The specific die holder 72A is provided with a through hole 94 to pass through the workpiece W after passing the workpiece W through the molding hole 74 of the specific die 71A, and an opening 95 to insert the horizontal members 80b of the stays 80. In a position corresponding to the molding hole 74, the through hole 94 is provided as a hole vertically penetrating a wall portion on a top side of the specific die holder 72A configured to support the specific die 71A. The through hole 94 is provided such that after passing through the molding hole 74 of the specific die 71A, the workpiece W can pass through the through hole 94 and move to below the specific die 71A, and also the knockout pin 75 can be inserted therein from below.

The opening 95 of the specific die holder 72A opens toward the downstream side in the workpiece transfer direction, and is provided to open an area under the specific die 71A to the downstream side in the workpiece transfer direction. The opening 95 opens the area under the specific die 71A to the downstream side in the workpiece transfer direction, such that the horizontal members 80b of the stays 80 extending toward the underside of the specific die 71A are inserted therein. Additionally, the opening 95 is configured such that, in addition to the horizontal members 80b of the stays 80, the under-die removal finger 81 disposed on the horizontal members 80b is inserted therein. Further in the present embodiment, the specific die holder 72A provided with the opening 95 is formed in a frame-like shape to support the specific die 71A. Further in the present embodiment, the specific die holder 72A formed in the frame-like shape has a gate-like shape. That is, the specific die holder 72A does not have dividing wall portions on left and right sides or a dividing wall portion on a bottom, and is formed in a gate-like shape in which both the left and right sides as well as the bottom are open.

Referring to FIGS. 1 to 4, in the lower die set 73 on which the die holders 72 of the plurality of press working units are placed, a step 73a is formed such that the specific die holder 72A is mounted in a lower height position in the up-and-down direction than a height position in the up-and-down direction of a mounting position of the die holder 72 of the press working unit preceding the press working unit including the specific die holder 72A. Accordingly, in the present embodiment, the lower die set 73 is configured such that a thickness in the up-and-down direction of the mounting position of the specific die holder 72A is thinner than a thickness of the mounting position of the die holder 72 of the press working unit preceding the press working unit including the specific die holder 72A. Then, the specific die holder 72A has a height dimension set to align a height position of an upper end surface thereof with that of the die holder 72 of the press working unit preceding the press working unit including the specific die holder 72A. Accordingly, in the present embodiment, the height position of the upper end surface of the specific die holder 72A is aligned with that of the die holder 72 other than the specific die holder 72A, but the height dimension of the specific die holder 72A is set to be larger than the height dimension of the die holder 72 other than the specific die holder 72A.

### 3. Operation of Press System and Transfer Device

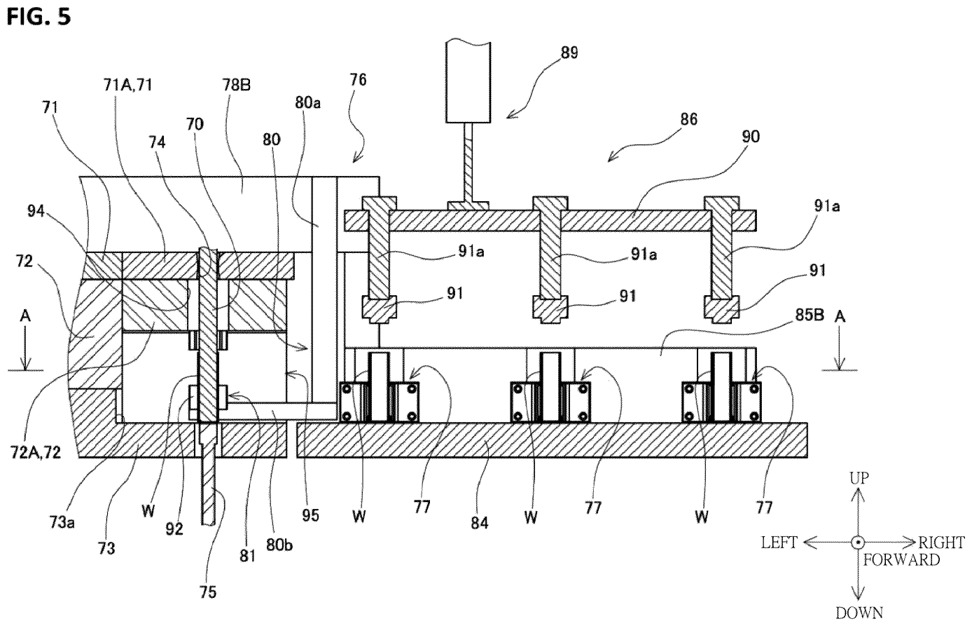

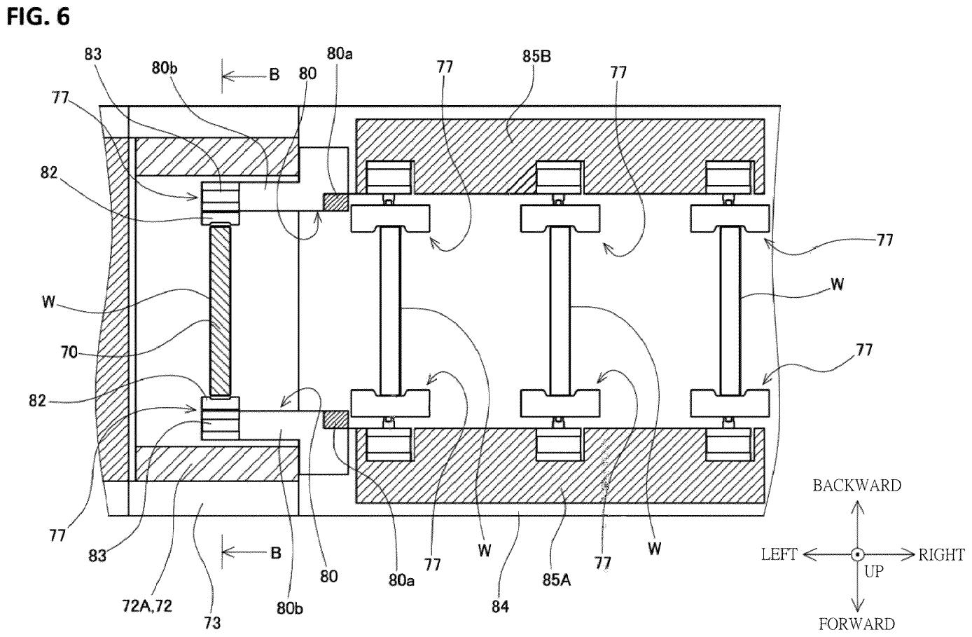

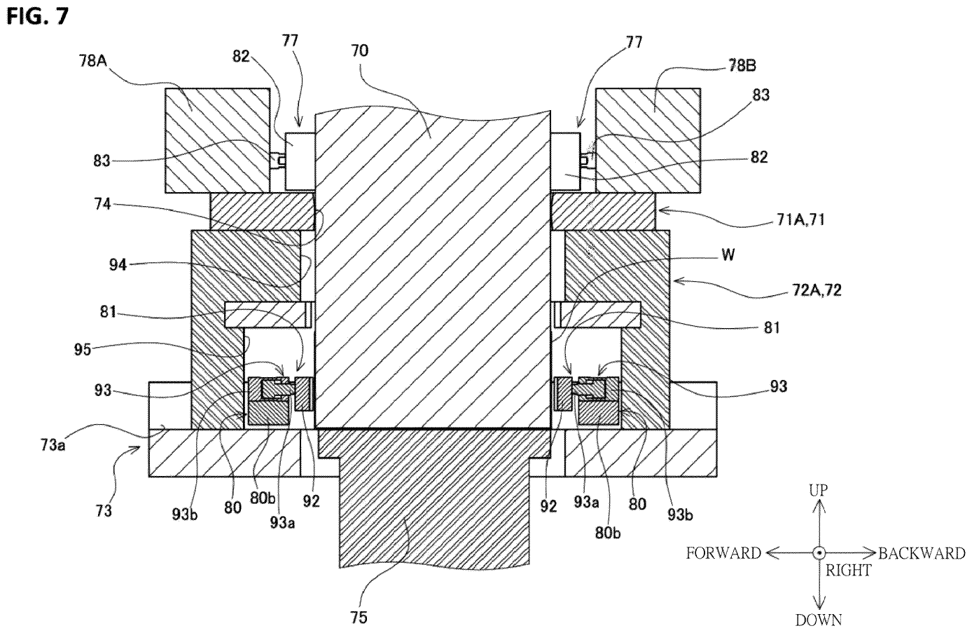

Next, operation of the press system 1 and the transfer device 76 of the present embodiment upon taking out the workpiece W from below the specific die 71A will be described. FIGS. 5 to 7 are cross-sectional views of a main part of the press system 1 for describing the operation of the press system 1 and the transfer device 76, showing a state subsequent to the press working by the specific die 71A. Note that FIG. 5 is a cross-sectional view of the main part of the press system 1, the cross section being taken along the left-and-right direction; FIG. 6 is a cross-sectional view of the main part of the press system 1, as viewed from the arrows A-A in FIG. 5; and FIG. 7 is a cross-sectional view of the main part of the press system 1, as viewed from the arrows B-B in FIG. 6. Additionally, FIGS. 5 to 7 show cross sections of the specific die 71A and the adjacent area thereto as the cross section of the main part of the press system 1.

Referring to FIGS. 5 to 7, when the press drawing process of the workpiece W is performed in the press working unit including the specific die 71A, the horizontal members 80b of the stays 80 of the transfer device 76 are inserted into the opening 95 of the specific die holder 72A, and the under-die removal finger 81 disposed on the horizontal members 80b is also inserted into the opening 95 and arranged below the specific die 71A. Then, once the press drawing process of the workpiece W is performed in the press working unit including the specific die 71A, the workpiece W passes through the molding hole 74 of the specific die 71A and moves to below the specific die 71A.

Once the workpiece W has passed through the molding hole 74 of the specific die 71A and moved to below the specific die 71A, the punch 70 is inserted into the workpiece W and the lower end of the workpiece W is supported by the knockout pin 75. Note that once the workpiece W subjected to the press drawing process in the press working unit including the specific die 71A has moved to below the specific die 71A, the knockout pin 75 rests in a position with the upper end of the knockout pin 75 at the same level as the top face of the lower die set 73. Therefore, the lower end of the workpiece W is supported by the knockout pin 75 at the same height position as the top face of the lower die set 73. Furthermore, once the workpiece W has moved to below the specific die 71A, the pair of finger body parts 92 of the under-die removal finger 81 is in the open state while the under-die removal finger 81 is inserted into the opening 95 of the specific die holder 72A and placed below the specific die 71A. Therefore, the workpiece W below the specific die 71A is separated from the pair of finger body parts 92, and not clamped by the under-die removal finger 81.

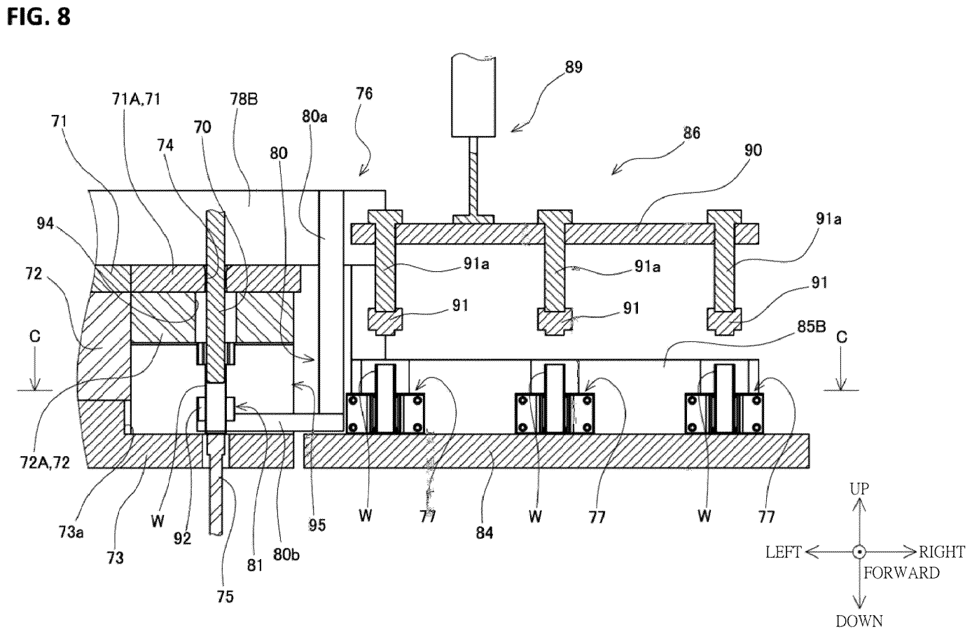

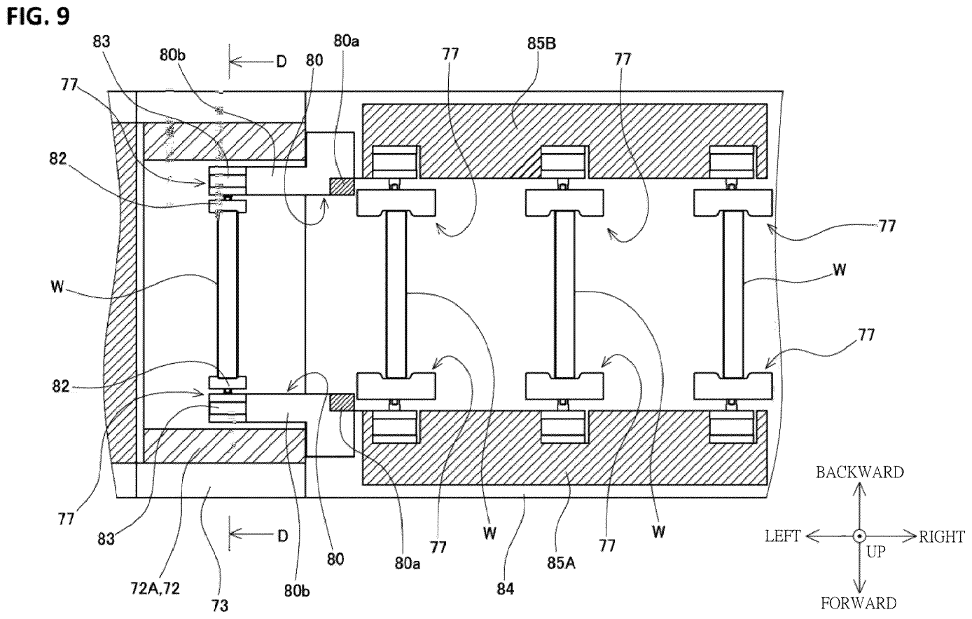

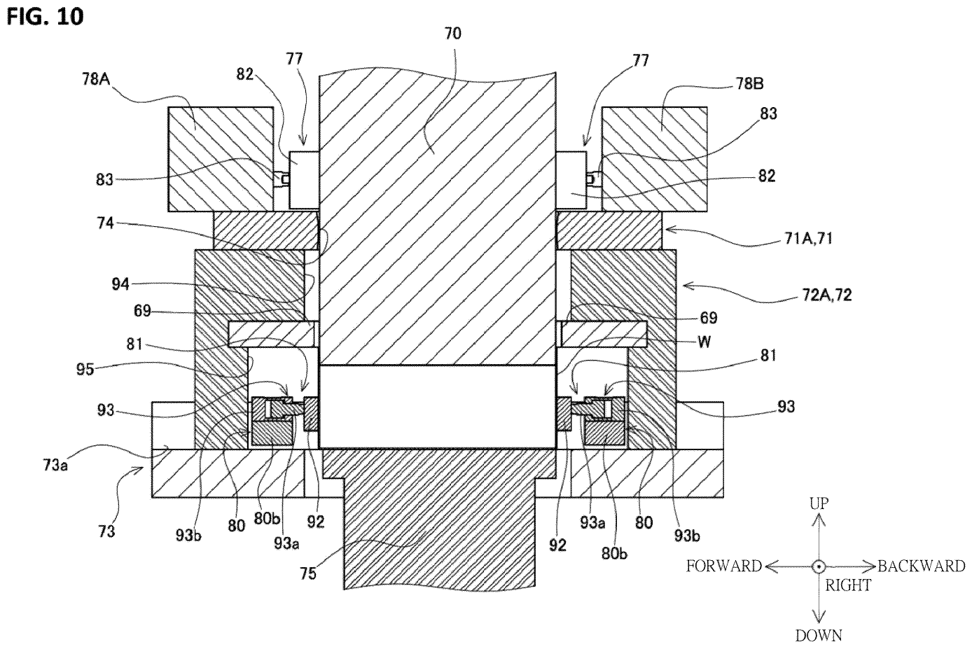

Once the workpiece W has moved to below the specific die 71A, operation of clamping the workpiece W by the under-die removal finger 81 is then performed. Additionally, once the workpiece W has moved to below the specific die 71A, a stripper 69 disposed inside the specific die holder 72A projects along the forward-and-backward direction until reaching a position where it can abut on the upper end of the workpiece W from above in the up-and-down direction while the punch 70 is inserted in the workpiece W (see FIG. 10). Note that the stripper 69 is configured such that a tip of the stripper 69 abuts on the upper end of the workpiece W from above, thereby regulating the upward movement of the workpiece W and releasing the workpiece W from the punch 70 during upwardly pulling the punch 70 out of the workpiece W. FIGS. 8 to 10 are cross-sectional views of the main part of the press system 1 for describing operation of the press system 1 and the transfer device 76, showing a state subsequent to the press working by the specific die 71A, where the under-die removal finger 81 is clamping the workpiece W. Note that FIG. 8 is a cross-sectional view of the main part of the press system 1, the cross section being taken along the left-and-right direction; FIG. 9 is a cross-sectional view of the main part of the press system 1, as viewed from the arrows C-C in FIG. 8; and FIG. 10 is a cross-sectional view of the main part of the press system 1, as viewed from the arrows D-D in FIG. 9. Additionally, FIGS. 8 to 10 show the cross sections of the specific die 71A and the adjacent area thereto as the cross section of the main part of the press system 1.

Referring to FIGS. 8 to 10, once the workpiece W has moved to below the specific die 71A, the operation of clamping the workpiece W by the under-die removal finger 81 is then performed while the workpiece W is kept supported by the punch 70 and the knockout pin 75. Furthermore, the stripper 69 projects toward the punch 70 along the forward-and-backward direction until reaching the position where it can abut on the upper end of the workpiece W from above in the up-and-down direction. Note that upon clamping the workpiece W by the under-die removal finger 81, the pair of air cylinders 93 of the under-die removal finger 81 is operated to drive the pair of finger body parts 92 in a direction approaching to each other. This causes the pair of finger body parts 92 to displace from the open state to the closed state and abut on the workpiece W from both sides in the forward-and-backward direction. Due to the pair of finger body parts 92 being in contact with the workpiece W from both sides in the forward-and-backward direction, the workpiece W is clamped by the under-die removal finger 81. When the workpiece W is clamped by the under-die removal finger 81 and the tip of the stripper 69 is in the position to abut on the upper end of the workpiece W from above, the punch 70 is upwardly pulled out of the specific die 71A. When the punch 70 is upwardly pulled out, the punch 70 is pulled out of the workpiece W and the workpiece W is released from the punch 70 due to the tip of the stripper 69 being in contact with the upper end of the workpiece W. Note that in a state that the punch 70 is pulled out of the workpiece W and the workpiece W is released from the punch 70, both sides of the workpiece W in the forward-and-backward direction are clamped by the pair of finger body parts 92, and the lower end of the workpiece W is supported on the upper end of the knockout pin 75, which is positioned at the same level as the top face of the lower die set 73.

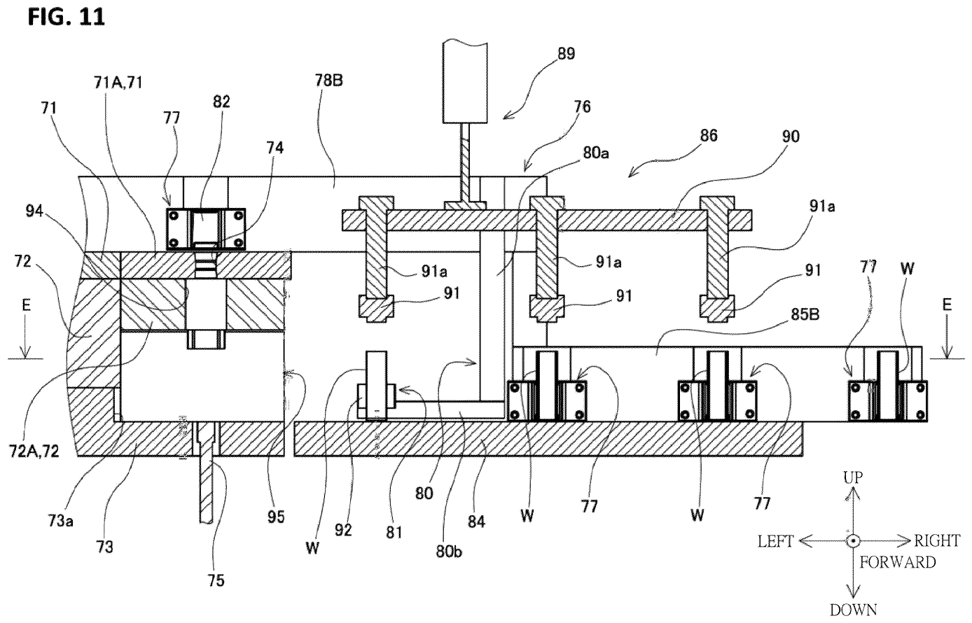

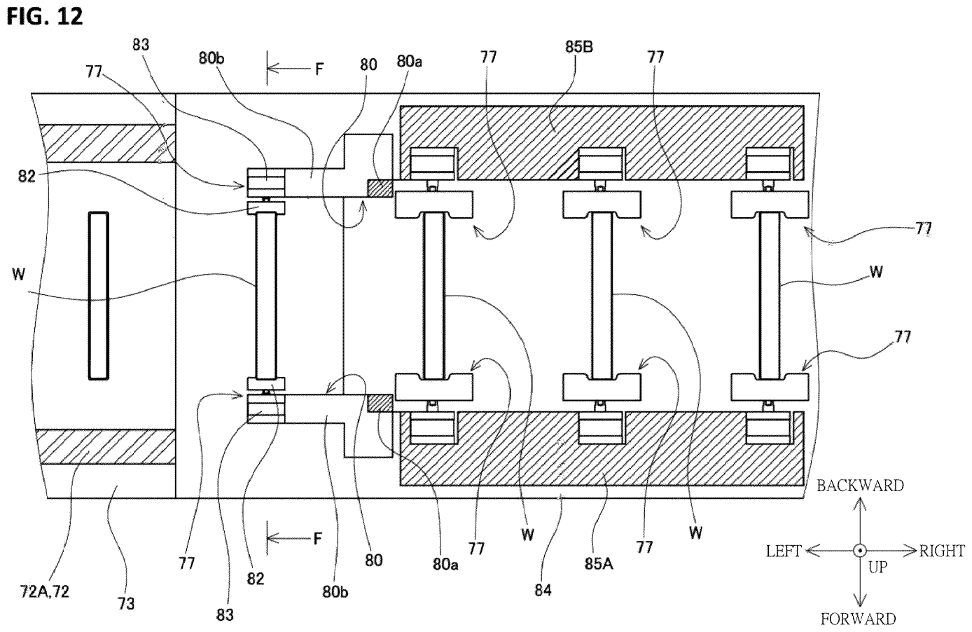

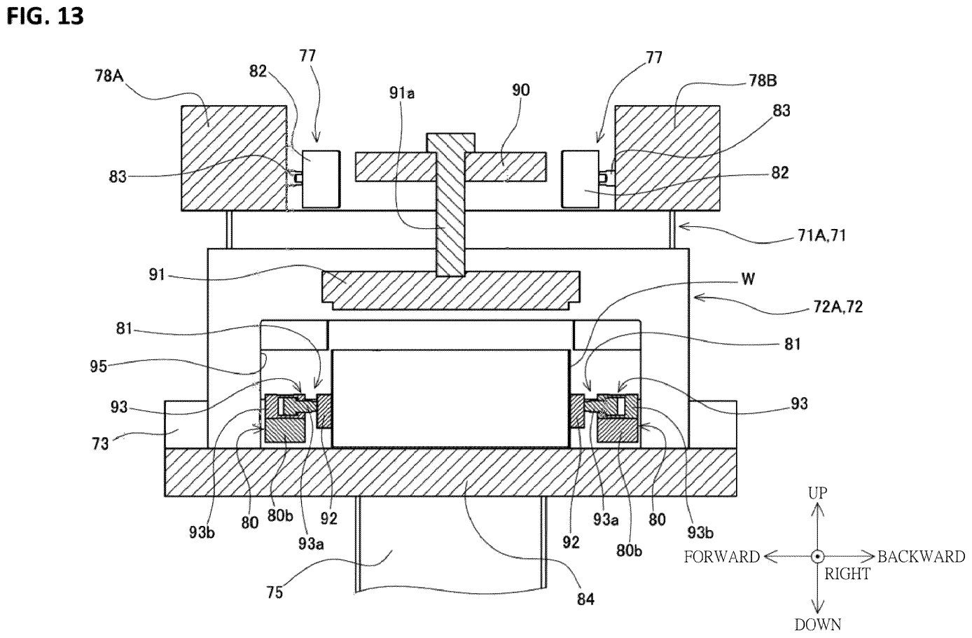

Once the workpiece W is released from the punch 70 and clamped by the under-die removal finger 81 below the specific die 71A, operation of taking out the workpiece W from below the specific die 71A to the downstream side in the workpiece transfer direction is then performed. FIG. 11 is a cross-sectional view of the main part of the press system 1 for describing operation of the press system 1 and the transfer device 76, where the workpiece W is taken out from below the specific die 71A. Note that FIG. 11 is a cross-sectional view of the main part of the press system 1, the cross section being taken along the left-and-right direction; FIG. 12 is a cross-sectional view of the main part of the press system 1, as viewed from the arrows E-E in FIG. 11; and FIG. 13 is a cross-sectional view of the main part of the press system 1, as viewed from the arrows F-F in FIG. 12. Additionally, FIGS. 11 to 13 show cross sections of the specific die 71A and the adjacent area thereto as the cross section of the main part of the press system 1.

Referring to FIGS. 11 to 13, once the workpiece W is clamped by the under-die removal finger 81 below the specific die 71A, the operation of taking out the workpiece W from below the specific die 71A to the downstream side in the workpiece transfer direction is then performed. On this occasion, while the under-die removal finger 81 is clamping the workpiece W below the specific die 71A, the pair of slide bars (78A, 78B) is driven by the drive unit 79 and moves to the downstream side in the workpiece transfer direction. When the pair of slide bars (78A, 78B) moves to the downstream side in the workpiece transfer direction, the pair of stays 80 also moves together with the pair of slide bars (78A, 78B) to the downstream side in the workpiece transfer direction. Then, the under-die removal finger 81 disposed on the pair of stays 80 also moves together with the pair of stays 80 to the downstream side in the workpiece transfer direction while clamping the workpiece W. This causes the workpiece W clamped by the under-die removal finger 81 below the specific die 71A to be taken out from below the specific die 71A to the downstream side in the workpiece transfer direction. Note that when the workpiece W clamped by the under-die removal finger 81 under the specific die 71A is taken out to the downstream side in the workpiece transfer direction, the workpiece W is transferred to the downstream side in the workpiece transfer direction while the lower end of the workpiece W is in sliding contact with the top face of the lower die set 73 and the upper end of the knockout pin 75 positioned at the same level as the top face of the lower die set 73.

Once the workpiece W is taken out from below the specific die 71A to the downstream side in the workpiece transfer direction, the air cylinder 89 of the workpiece hold down mechanism 86 is operated, so that the workpiece pressers 91 descend and hold down the workpiece W, resulting in a state that the workpiece W is supported by the workpiece hold down mechanism 86. Once the workpiece W is supported by the workpiece hold down mechanism 86, the pair of air cylinders 93 of the under-die removal finger 81 is operated to drive the pair of finger body parts 92 in a direction away from each other. This causes the pair of finger body parts 92 to displace from the closed state to the open state to release the workpiece W from the clamped state. Once the workpiece W is released from the clamped state, the pair of slide bars (78A, 78B) is driven by the drive unit 79 and moves toward the upstream side in the workpiece transfer direction. When the pair of slide bars (78A, 78B) moves to the upstream side in the workpiece transfer direction, the pair of stays 80 also moves together with the pair of slide bars (78A, 78B) to the upstream side in the workpiece transfer direction. Then, the under-die removal finger 81 disposed on the pair of stays 80 also moves together with the pair of stays 80 to the upstream side in the workpiece transfer direction. This causes the under-die removal finger 81 together with the horizontal members 80b of the stays 80 to be inserted into the opening 95 of the specific die holder 72A and placed below the specific die 71A. Once the under-die removal finger 81 is placed below the specific die 71A, the press drawing process of the workpiece W is performed again in the press working unit having the specific die 71A.

### 4. Effect of Present Embodiment

With the press system 1 and the transfer device 76 of the present embodiment, the plurality of transfer fingers 77 for clamping the workpiece W are disposed on the slide bars (78A, 78B), which are driven to reciprocate, and the stays 80 on the slide bars (78A, 78B) extend toward the underside of the specific die 71A. Then, the under-die removal finger 81 for clamping the workpiece W moved to below the specific die 71A is provided on the stays 80. This makes it possible to take out the workpiece W from below the specific die 71A by clamping the workpiece W passed through the specific die 71A with the under-die removal finger 81 and driving the slide bars (78A, 78B). Further, with the press system 1 and the transfer device 76 of the present embodiment, it is possible to take out the workpiece W from below the specific die 71A by the small and simple mechanism, in which the slide bars (78A, 78B) are respectively provided with the stays 80 extending from the slide bars (78A, 78B) toward the underside of the specific die 71A, and the under-die removal finger 81 is disposed on the stays 80.

As described above, with the press system 1 and the transfer device 76 of the present embodiment, it is possible to take out the workpiece W from below the die 71A, and also achieve miniaturization and simplification of the device.

Furthermore, with the press system 1 and the transfer device 76 of the present embodiment, the stays 80, which extend from the slide bars (78A, 78B) toward the underside of the specific die 71A and have the under-die removal finger 81 disposed thereon, can each be configured as a simple structure provided with a member (the vertical member 80a and the horizontal member 80a), which is secured to the slide bars (78A, 78B) and extends from the slide bars (78A, 78B) toward the underside of the specific die 71A. Accordingly, it is possible to achieve further miniaturization and simplification of the device.

Furthermore, with the press system 1 of the present embodiment, since the opening 95 to insert the stays 80 is disposed in the specific die holder 72A configured to support the specific die 71A, below which the workpiece W is taken out, it is possible to easily insert the stays 80 below the specific die 71A.

Furthermore, with the press system 1 of the present embodiment, the specific die holder 72A is formed in the frame-like shape to support the specific die 71A, so that the wide opening 95 to insert the stays 80 can be formed. Additionally, since the specific die holder 72A has the frame-like shape, it can have a structure including leg portions on both sides of the opening 95, and can stably support the specific die 71A regardless of the opening 95 disposed in the specific die holder 72A.

Furthermore, with the press system 1 of the present embodiment, the height of the upper end surface of the specific die holder 72A corresponds to the height of the upper end surface of the die holder 72 for the previous process, and in the lower die set 73, the step 73a having a decreased height is provided in the mounting position of the specific die holder 72A. Accordingly, it is possible to form a vertically wide space to insert the stays 80 in the specific die holder 72A configured to support the specific die 71A, below which the workpiece W is taken out. This enables the stays 80 to be easily inserted under the specific die 71A.

### 5. Modifications

The embodiment of the present invention has been described above, but the present invention is not limited to the above-described embodiment. Various modifications can be made within the scope of the claims. For example, modifications as follows may be implemented.

(1) In the above-described embodiment, described is the example in which the height of the upper end surface of the specific die holder 72A is aligned with that of the die holder 72 for the previous process, and the step 73a having a decreased height is provided in the mounting position of the specific die holder 72A in the lower die set 73, but the present invention is not limited thereto. Even when the step 73a is not provided on the lower die set 73, a modification of the press system may be implemented, where a vertically wide space to insert the stays 80 is formed in the specific die holder 72A to allow easy insertion of the stays 80 under the specific die 71A.

In the press system according to the present modification, the lower die set 73 is formed in a flat plate shape with no step 73a, on which the plurality of press working units each including the die 71 and the die holder 72 configured to support the die 71 are mounted. On the lower die set 73, the die holders 72 of the plurality of press working units are placed. Then, the specific die holder 72A is disposed such that the upper end surface thereof is at the same height position as that of the die holder 72 of the press working unit preceding the press working unit including the specific die holder 72A. Further, the height dimension of the die holder 72 of the press working unit preceding the press working unit including the specific die holder 72A is set to be aligned with the height dimension of the specific die holder 72A. According to this modification, the height of the upper end surface of the specific die holder 72A corresponds to that of the die holder 72 for the previous process, and the height dimension of the die holder 72 for the previous process is set to correspond to the height dimension of the specific die holder 72A. Accordingly, it is possible to produce the die holder 72 for the previous process and the specific die holder 72A in the standardized and the same external form. Moreover, by appropriately setting the height dimensions of the die holder 72 for the previous process and the specific die holder 72A high, it is possible to form a vertically wide space to insert the stays 80 in the specific die holder 72A, thereby easily inserting the stays 80 under the specific die 71A. Furthermore, by reducing the thickness of the wall portion on the top side of the specific die holder 72A and setting the height of the space inside the specific die holder 72A high, it is possible to form a vertically wide space to insert the stays 80 in the specific die holder 72A, thereby easily inserting the stays 80 under the specific die 71A.

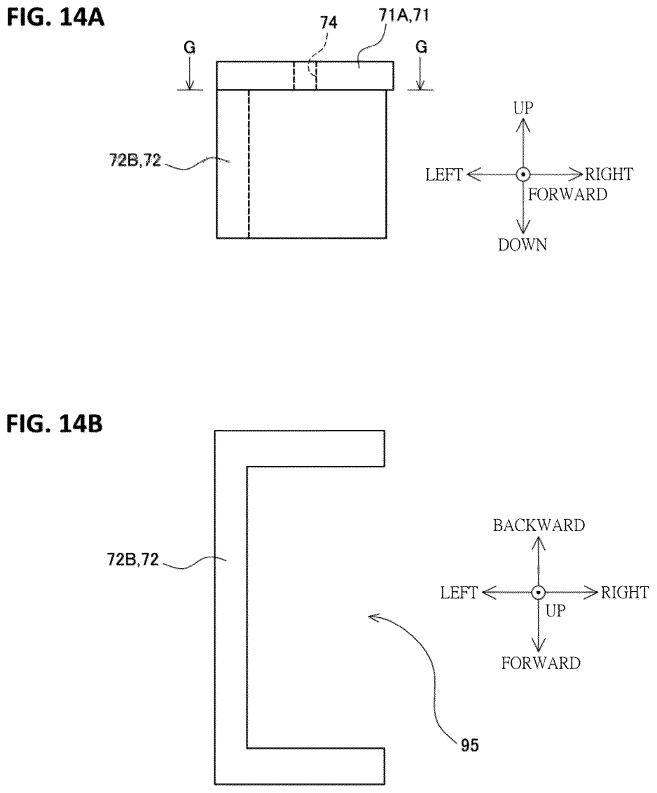

(2) In the above-described embodiment, described is the example in which the specific die holder 72A configured to support the specific die 71A is formed in the gate-like shape, but the present invention is not limited thereto. The specific die holder supporting the specific die 71A may be implemented by changing its shape to various shapes different from the shape of the specific die holder 72A. For example, shapes of specific die holders (72B-72E) according to modifications shown in FIGS. 14 to 17 may be implemented. Note that in the description below regarding the specific die holders (72B-72E) according to the modifications, the element configured in the same manner as in the above-described embodiment, and the element configured in the corresponding manner to the above-described embodiment are denoted by the same sign in the drawings or refers to the same sign or term, thereby omitting the redundant description thereof.

FIG. 14 is a diagram for describing the shape of the specific die holder 72B according to the modification. Note that FIG. 14A shows the specific die holder 72B and the specific die 71A viewed from the front side, and FIG. 14B is viewed from the arrows G-G in FIG. 14A. Referring to FIG. 14, the specific die holder 72B is formed in a frame-like shape to support the specific die 71A. More specifically, the specific die holder 72B does not have dividing wall portions on the top and bottom or a dividing wall portion on the right side, i.e. the downstream side in the workpiece transfer direction, and formed in a frame-like shape with both the top and bottom as well as the right side thereof open. Note that in this specific die holder 72B, the specific die 71A is supported on the upper ends of the wall portions on the forward, backward, and left sides. Then, in the open area on the right side of the specific die holder 72B, the opening 95 to insert the stays 80 is formed. The specific die holder 72B having such a frame-like shape may be implemented.

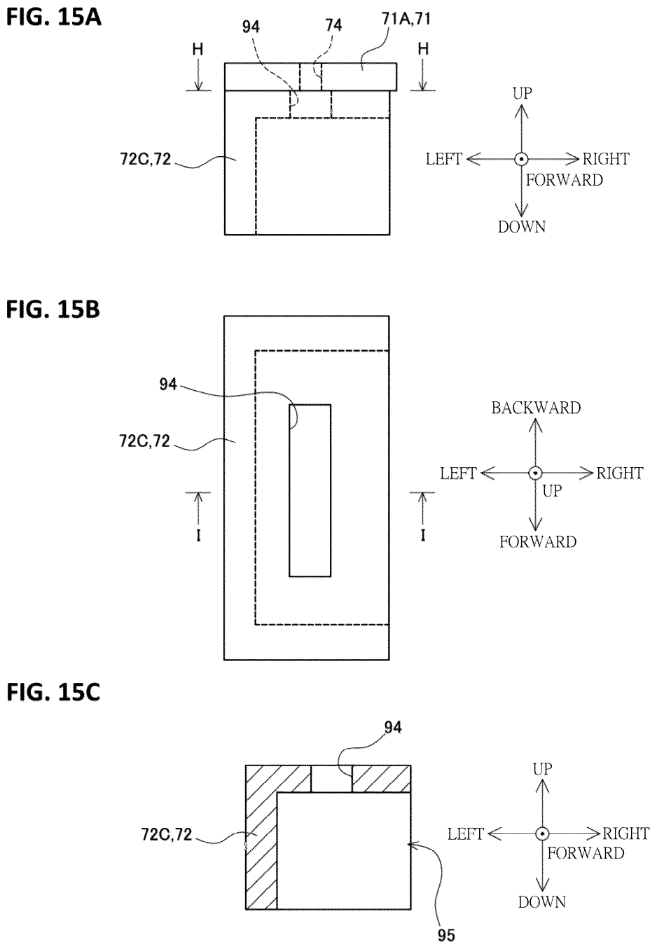

FIG. 15 is a diagram for describing the shape of the specific die holder 72C according to the modification. Note that FIG. 15A shows the specific die holder 72C and the specific die 71A viewed from the front side, FIG. 15B is viewed from the arrows H-H in FIG. 15A, and FIG. 15C is a cross-sectional view, as viewed from the arrows I-I in FIG. 15B. Referring to FIG. 15, the specific die holder 72C is formed in a frame-like shape to support the specific die 71A. More specifically, the specific die holder 72C does not have a dividing wall portion on the bottom or a dividing wall portion on the right side, i.e. the downstream side in the workpiece transfer direction, and is formed in a frame-like shape with the bottom and the right side thereof open. Note that in this specific die holder 72C, the specific die 71A is supported on the wall portion on the top side. Then, in the open area on the right side of the specific die holder 72C, the opening 95 to insert the stays 80 is formed. The specific die holder 72C having such a frame-like shape may be implemented.

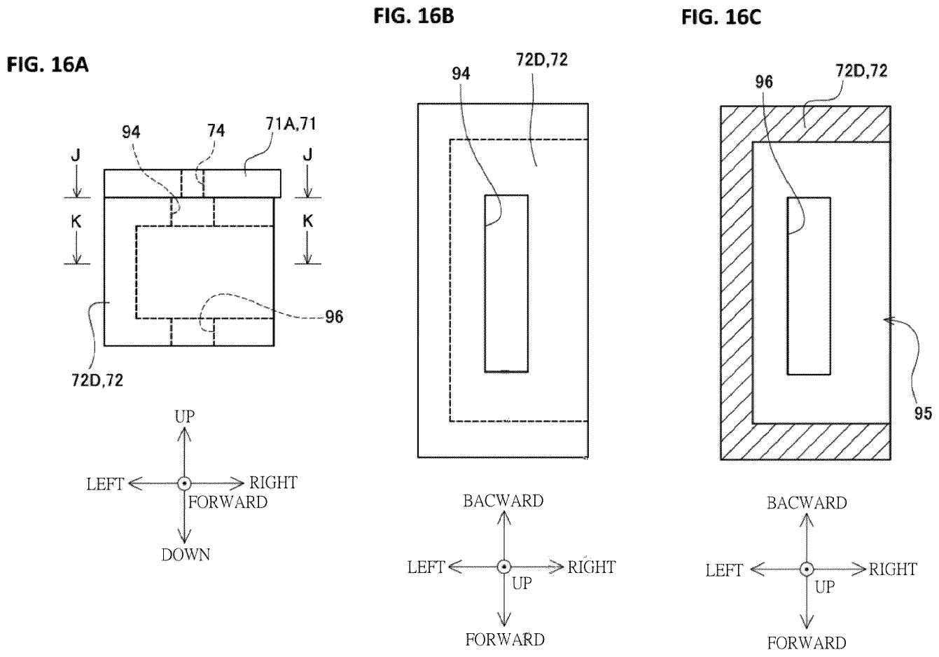

FIG. 16 is a diagram for describing the shape of the specific die holder 72D according to the modification. Note that FIG. 16A shows the specific die holder 72D and the specific die 71A viewed from the front side, FIG. 16B is viewed from the arrows J-J in FIG. 16A, and FIG. 16C is a cross-sectional view, as viewed from the arrows K-K in FIG. 16A. Referring to FIG. 16, the specific die holder 72D is formed in a frame-like shape to support the specific die 71A. More specifically, the specific die holder 72D does not have a dividing wall portion on the right side, i.e. the downstream side in the workpiece transfer direction, and is formed in a frame-like shape with its right side open. Note that in this specific die holder 72D, the specific die 71A is supported on the wall portion on the top side. Then, in the open area on the right side of the specific die holder 72D, the opening 95 to insert the stays 80 is formed. Additionally, in the wall portion on the bottom side of the specific die holder 72D, the through hole 96 to pass through the knockout pin 75 is disposed. The specific die holder 72D having such a frame-like shape may be implemented.

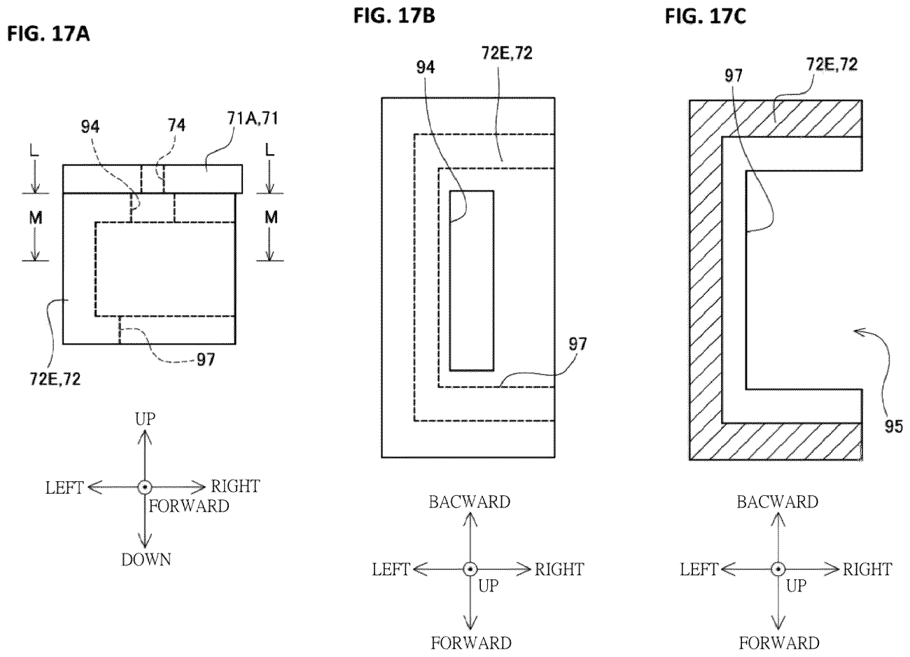

FIG. 17 is a diagram for describing the shape of the specific die holder 72E according to the modification. Note that FIG. 17A shows the specific die holder 72E and the specific die 71A viewed from the front side, FIG. 17B is viewed from the arrows L-L in FIG. 17A, and FIG. 17C is a cross-sectional view, as viewed from the arrows M-M in FIG. 17A. Referring to FIG. 17, the specific die holder 72E is formed in a frame-like shape to support the specific die 71A. More specifically, the specific die holder 72E does not have a dividing wall portion on the right side, i.e. the downstream side in the workpiece transfer direction, and is formed in a frame-like shape with its right side open. Note that in this specific die holder 72E, the specific die 71A is supported on the wall portion on the top side. Then, in the open area on the right side of the specific die holder 72E, the opening 95 to insert the stays 80 is formed. Additionally, on the wall portion on the bottom side of the specific die holder 72E, a notch area 97 cutout as a recessed shape is provided as an area to pass through the knockout pin 75. The specific die holder 72E having such a frame-like shape may be implemented.

(3) In the above-described embodiment, described as the example of the transfer finger 77 disposed on the slide bars (78A, 78B) is the transfer finger 77 including: the finger body parts 82 for clamping the workpiece W; and the air cylinders 83 that are attached to the slide bars (78A, 78B) and drive the finger body parts 82 to open and close, but the present invention is not limited thereto. In the transfer finger 77, the mechanism for driving the finger body parts 82 to open and close may not be an actuator such as the air cylinders 83, and may be a mechanism using a compression spring and a spreader. In this modification, for example, it may be configured to use the compression spring to drive the finger body parts 82 in a closing direction, and use the spreader to drive the finger body parts 82 in an opening direction.

(4) In the above-described embodiment, described is the example of the configuration of the under-die removal finger 81 including: the air cylinders 93 attached to the stays 80; and the finger body parts 92 that are attached to the air cylinders 93 and driven by the air cylinders 93 to open and close, but the present invention is not limited thereto. A configuration of the under-die removal finger may be implemented, where the stay is divided into two members; an actuator such as an air cylinder is disposed on one of the two members and one of the two members is coupled to the other member by the actuator; finger body parts are further disposed on the other members; and the finger body parts are driven to open and close together with the other members by the actuator. Note that, more preferably, a guide member may be provided to guide reciprocating movement of the other member of the stay and the finger body parts driven by the actuator in the direction perpendicular to the workpiece transfer direction.

(5) In the above-described embodiment, described is the example in which the stays 80 extending from the slide bars (78A, 78B) toward the underside of the specific die 71A are secured to the slide bars (78A, 78B), but the present invention is not limited thereto. It may be configured to couple the stays to the slide bars (78A, 78B) via actuators, and drive the under-die removal finger disposed on the stays to open and close together with the stays by the actuators. Note that, more preferably, guide members may be provided to guide reciprocating driving of the stays and the under-die removal finger, which are driven by the actuators in the direction perpendicular to the workpiece transfer direction.

(6) In the above-described embodiment, described as the example of the under-die removal finger 81 disposed on the stays 80 is the under-die removal finger 81 including: the finger body parts 92 for clamping the workpiece W; and the air cylinders 93 that are attached to the stays 80 and drive the finger body parts 92 to open and close, but the present invention is not limited thereto. In the under-die removal finger 81, the mechanism for driving the finger body parts 92 to open and close may not be actuators such as the air cylinders 93, but may be a mechanism using compression springs and spreaders. In this modification, for example, it may be configured to use the compression springs to drive the finger body parts 92 in a closing direction and use the spreaders to drive the finger body parts 92 in an opening direction.

### REFERENCE NUMERALS

1 Press system
70 Punch
71 Die
71A Specific die
72 Die holder
72A Specific die holder
73 Lower die set
74 Molding hole
76 Transfer device
77 Transfer finger
78A, 78B Slide bar
79 Drive unit
80 Stay
81 Under-die removal finger
W Work

1. A press system comprising a plurality of press working units each comprising a die and a punch to perform a plurality of press drawing processes on a workpiece, the press system further comprising:
a transfer device that transfers the workpiece processed in one of the plurality of press working units to a next press working unit,
wherein the transfer device comprises:
a plurality of transfer fingers provided to clamp the workpiece from both sides in a direction perpendicular to a transfer direction of the workpiece;
a pair of slide bars extending along the transfer direction, on which the plurality of transfer fingers are disposed;
a drive unit that drives the slide bars to reciprocate along the transfer direction;
stays extending from the slide bars toward an underside of a specific die, the specific die being the die of any press working unit of the plurality of press working units; and
an under-die removal finger disposed on the stays, the under-die removal finger clamping the workpiece that has passed through a molding hole of the specific die and moved to below the specific die.

2. The press system as claimed in claim 1, wherein
the press working unit comprising the specific die comprises a specific die holder configured to support the specific die, and
the specific die holder is provided with an opening to insert the stays.

3. The press system as claimed in claim 2, wherein the specific die holder is formed in a frame-like shape to support the specific die.

4. The press system as claimed in any one of claims 1 to 3, wherein each of the stays comprises a member that is secured to one of the slide bars and extends from the slide bars toward an underside of the specific die.

5. The press system as claimed in any one of claims 1 to 3, further comprising a lower die set on which the plurality of press working units each comprising the die and a die holder configured to support the die are mounted, wherein
the die holder of each of the plurality of press working units is mounted on the lower die set,
the lower die set comprises a step formed such that a height position of a mounting position of the specific die holder is lower than a height position of a mounting position of the die holder of the press working unit preceding the press working unit comprising the specific die holder, and
the specific die holder has a height dimension set to align a height position of an upper end surface of the specific die holder with a height position of an upper end surface of the die holder of the press working unit preceding the press working unit comprising the specific die holder.

6. The press system as claimed in any one of claims 1 to 3, further comprising a lower die set on which the plurality of press working units each comprising the die and a die holder configured to support the die are mounted, wherein
the die holder of each of the plurality of press working units is mounted on the lower die set,
the specific die holder is disposed to align a height position of an upper end surface of the specific die holder with an upper end surface of the die holder of the press working unit preceding the press working unit comprising the specific die holder, and
the die holder of the press working unit preceding the press working unit comprising the specific die holder has a height dimension set to be aligned with a height dimension of the specific die holder.

7. A transfer device to be used for a press system comprising a plurality of press working units each comprising a die and a punch to perform a plurality of press drawing processes on a workpiece, the transfer device transferring the workpiece processed in one of the plurality of press working unit to a next press working unit, the transfer device comprising:
a plurality of transfer fingers provided to clamp the workpiece from both sides in a direction perpendicular to a transfer direction of the workpiece;
a pair of slide bars extending along the transfer direction, on which the plurality of transfer fingers are disposed;
a drive unit that drives the slide bars to reciprocate along the transfer direction;
stays extending from the slide bars toward an underside of a specific die, the specific die being the die of any press working unit of the plurality of press working units; and
an under-die removal finger disposed on the stays, the under-die removal finger clamping the workpiece that has passed through a molding hole of the specific die and moved to below the specific die.

8. The transfer device as claimed in claim 7, wherein each of the stays comprises a member that is secured to one of the slide bars and extends from the slide bars toward an underside of the specific die.
